(19) United States
(12) Patent Application Publication
(10) Pub. No.: US 2026/0056522 A1
(43) Pub. Date: Feb. 26, 2026

(54) SWITCHING POSITION OF DUAL MODALITY COUPLING MODULE TO REDUCE VIBRATIONS IN MACHINE

(71) Applicant: International Business Machines Corporation, Armonk, NY (US)

(72) Inventors: Sarbajit Kumar Rakshit, Kolkata (IN); Binoy Thomas, Kozhikode (IN); Sudheesh S. Kairali, Kozhikode (IN)

(21) Appl. No.: 18/809,387

(22) Filed: Aug. 20, 2024

(51) Int. Cl. G05B 17/02

(52) U.S. Cl. CPC G05B 17/02

(57) ABSTRACT

Switching a position of a dual modality coupling module to reduce vibrations in a machine includes simulating the propagation of vibrations through the machine using a digital twin model. The simulation is used in determining vibration levels at points of interest in the machine and a recommendation is generated to use the dual modality coupling module based on the vibration levels and the defined vibration threshold. If the vibration levels fail to satisfy the vibration threshold, the dual modality coupling module is positioned at the mechanical coupling position. Upon determining that the vibration levels satisfy the defined vibration threshold, a signal is generated to regulate a current flow to magnetic coils of the dual modality coupling module. The current flow induces temporary magnetism in the magnetic coils. As a result, a mechanical coupling position is switched to a magnetic coupling position.

### BACKGROUND

The disclosure relates generally to the field of control systems, more particularly, to switching a position of a dual modality coupling module to reduce vibrations in a machine.

Machines are utilized to perform various tasks, such as drilling, cutting, grinding, mixing, and the like. The machines typically include rotating shafts, which upon receiving power, induce motion into components of the machine to act upon an activity area or a target. Further, two or more components of the machines are connected, such that they work together to transmit power, motion, or signals while maintaining certain operational characteristics. Coupling refers to a mechanism that connects two rotating shafts, enabling the transfer of torque and rotational motion between them. Coupling is classified as a mechanical coupling and a magnetic coupling. The mechanical couplings require physical contact, which can lead to wear and tear, friction, and potential leakage, especially in sealed environments or when working with hazardous materials. In contrast, the magnetic couplings transmit power without physical contact. The magnetic couplings use magnetic fields to transfer torque. The magnetic coupling renders hermetic sealing, reduced wear and friction, and elimination of leakage risks. Further, the magnetic couplings are particularly utilized in applications requiring airtight seals, such as chemical processing and medical devices. Additionally, the magnetic couplings isolate driving and driven components, minimizing the impact of vibrations and shocks, and are capable of transmitting significant torque, suitable for heavy-duty applications. The absence of physical contact results in lower maintenance and enhanced reliability.

### SUMMARY

According to some embodiments of the disclosure, a computer-implemented method for switching the position of a dual modality coupling module is described. The computer-implemented method comprises simulating the propagation of vibration resulting from application of a force on a machine by using a computer. The propagation of the vibration results from the application of a force on the machine. The simulation of the propagation of vibration is based on a digital twin model. The computer-implemented method further includes determining, by the computer, a vibration level at one or more points of interest of the machine based on the simulated propagation of the vibration. Furthermore, the computer-implemented method includes generating, by the computer, a recommendation to use a dual modality coupling module. The recommendation is generated based on the determined vibration level of the one or more points of interest.

According to some embodiments of the disclosure, the system for switching the position of a dual modality coupling module is described. The system performs a method for switching the position of the dual modality coupling module. The method includes obtaining a vibration level for each of one or more points of interest associated with a machine. The method further includes determining a position of a dual modality coupling module based on the obtained vibration level and a defined vibration threshold. The determined position is one of a mechanical coupling position or a magnetic coupling position. The method includes generating a first signal to switch the dual modality coupling module from the magnetic coupling position to the mechanical coupling position. The first signal is generated when the obtained vibration level fails to satisfy the defined vibration threshold. The method includes generating a second signal to switch the dual modality coupling module from the mechanical coupling position to the magnetic coupling position. The second signal is generated when the obtained vibration level satisfies the defined vibration threshold. The method includes transmitting the first signal and the second signal to the dual modality coupling module to switch between the mechanical coupling position and the magnetic coupling position. The switch between the mechanical coupling position and the magnetic coupling position is based on the regulation of a current flow in a first set of magnetic coils and a second set of magnetic coils of the dual modality coupling module.

In some embodiments, the computer program product to switch the position of a dual modality coupling module is described. The computer program product includes a computer-readable storage medium having program instructions embodied therewith. The program instructions are executable by a system to cause the system to obtain a vibration level for each of one or more points of interest associated with a machine. The program instructions further include determining a position of the dual modality coupling module for coupling based on the obtained vibration level and a defined vibration threshold, where the determined position is one of a mechanical coupling position or a magnetic coupling position. The program instructions include generating a first signal to switch the dual modality coupling module from the magnetic coupling position to the mechanical coupling position. The first signal is generated in a case where the obtained vibration level fails to satisfy the defined vibration threshold. The program instructions include generating a second signal to switch the dual modality coupling module from the mechanical coupling position to the magnetic coupling position. The second signal is generated when the obtained vibration level satisfies the defined vibration threshold. Further, the program instructions include transmitting the first signal and the second signal to the dual modality coupling module to switch between the mechanical coupling position and the magnetic coupling position. The switch between the mechanical coupling position and the magnetic coupling position is based on regulating a current flow in a first set of magnetic coils and a second set of magnetic coils of the dual modality coupling module.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a block diagram that illustrates a computing environment for switching a position of a dual modality coupling module, in accordance with an embodiment of the disclosure;

FIG. 2 is a diagram that illustrates an environment for switching the position of the dual modality coupling module, in accordance with an embodiment of the disclosure;

FIG. 3 is a flow chart that illustrates exemplary operations for recommending the use of dual modality coupling module, in accordance with an embodiment of the disclosure;

FIG. 4 is a flow chart that illustrates exemplary operations for switching the position of the dual modality coupling module, in accordance with an embodiment of the disclosure;

FIG. 5A is a diagram that illustrates a side view of the dual modality coupling module configuration, in accordance with another embodiment of the disclosure;

FIG. 5B is a diagram of a cross-sectional side view of the dual modality coupling module configuration, in accordance with an embodiment of the disclosure;

FIG. 5C is a diagram of a front view of the dual modality coupling module configuration, in accordance with an embodiment of the disclosure;

FIG. 6 is diagram of a process of contextual switching of coupling positions of the dual modality coupling module based on the outcome of digital twin simulation, in accordance with an embodiment of the disclosure;

FIG. 7 is a flow chart illustrating a computer-implemented method for determining a coupling position of the dual-modality coupling based on an outcome of digital twin model simulation, in accordance with an embodiment of the disclosure; and

FIG. 8 is a flow chart illustrating a method for switching coupling positions of the dual modality coupling module, in accordance with an embodiment of the disclosure.

### DETAILED DESCRIPTION

Mechanical couplings require physical contact, which can lead to wear and tear, friction, and potential leakage, especially in sealed environments or when working with hazardous materials. Magnetic coupling is a mechanism that transfers torque and rotational motion through a magnetic field without requiring physical contact between driving and driven components. The magnetic coupling uses magnets to transmit power, typically in situations where traditional mechanical couplings might be impractical or where a sealed environment is required.

Further, the magnetic coupling is implemented for hermetic sealing, reduced wear and friction, and elimination of leakage risks. It allows for the isolation of driving and driven components, ensuring smoother operation and improved precision. The magnetic couplings can transmit significant torque and require less maintenance, resulting in higher reliability over time. However, magnetic coupling performs power transmission with high torque, resulting in heat generation due to magnetic field interactions. Furthermore, the magnetic coupling also sustains variations in efficiency influenced by factors, such as magnetic material properties, air gap distance, and operating speed.

Vibration in machines may accelerate wear rates, reducing bearing life, and causing damage to equipment. Vibrating machines can also create noise, cause safety issues, and lead to degradation of plant working conditions. Further, the vibration can cause machines to consume excessive power and potentially damage product quality. In extreme cases, the vibration can severely damage equipment, halting plant production. It may therefore be imperative to have a method and system to determine the impacts of predicted vibrations on a machine, and accordingly, switch the coupling position between a magnetic coupling position and a mechanical coupling position.

According to an aspect of some exemplary embodiments, a computer-implemented method includes simulating the propagation of vibration caused by application of a force on a machine. The simulation is based on a digital twin model. The computer-implemented method includes determining the vibration level at one or more points of interest of the machine based on the simulated propagation of the vibration. The computer-implemented method includes generating a recommendation to use a dual modality coupling module. The recommendation is generated based on the vibration level of the one or more points of interest. Thus, the method predicts vibration levels by simulating the digital twin model. Based on the predictions, the method performs generation of the recommendation to utilize the dual modality coupling module. The method enhances predictive maintenance and operational efficiency by anticipating and mitigating potential vibration-induced damage.

In some embodiments, the computer-implemented method includes simulating the propagation of the vibration through the machine based on the digital twin model. The simulation includes obtaining data associated with an activity performed by the machine, where the data includes at least one of a layout, equipment, or operational parameters associated with the machine. The computer-implemented method includes generating a first model representing the geometrical properties and mechanical properties of the machine based on the obtained data. The computer-implemented method also includes generating a second model representing one or more physical properties of the machine and its components, based on the obtained data. The digital twin model is simulated by the computer based on the first model and the second model. Thus, the method creates detailed simulation based on comprehensive data inputs, including layout, equipment, and operational parameters, and enhances the accuracy of the vibration propagation simulation and subsequent analyses.

In some embodiments, the second model represents material properties of the components, interactions observed between the components, responses of the components to the force, loads applied to the machine, and the position of the center of gravity. Thus, the computer-implemented method improves precision in simulating vibration propagation by incorporating detailed material properties, interaction responses, and load dynamics. Precise simulation leads to more accurate predictions and better decision-making regarding the machine's operational parameters.

In some embodiments, the computer-implemented method includes predicting a response of the machine based on the application of the force by the computer. The response of the machine is predicted based on generating a damper model, which is based on the natural frequency of the machine and a damping coefficient of the machine. The computer-implemented method includes determining the vibration level at one or more points of interest associated with the machine, where the vibration level is determined based on the damper model and the magnitude of the force. Thus, the computer-implemented method predicts the machine's response to applied forces using a damper model, which enhances the accuracy of vibration level determination and helps in designing recommendations of mitigation strategies.

In some embodiments, the computer-implemented method includes determining the impact of the propagation of the vibration on the machine by the computer, where the impact of the propagation of the vibration corresponds to negative effects of vibrating movements on the components of the machine. The computer-implemented method includes identifying one or more vibration frequencies of the machine based on the determined impact, where the force causes the impact on the machine at the one or more vibration frequencies. The computer-implemented method includes identifying one or more natural frequencies of the machine. The computer-implemented method includes determining a damage value resulting from a resonance frequency based on the determination that the natural frequencies match with the vibration frequencies. The identification of potential resonance frequencies and associated damage values, contributes to preemptively addressing issues that could lead to significant wear and tear or failure of machine components.

In some embodiments, the computer-implemented method includes applying the force to the digital twin model by the computer. The computer-implemented method includes monitoring the propagation of the vibration caused by the force at the digital twin model. The force is applied through at least one of a target location of the machine or a component of the machine. The computer-implemented method includes identifying changes in vibration amplitudes of the propagated vibration during its transmission from a source location of the machine to at least one of the target location or the component of the machine, where the changes in the vibration amplitudes are identified based on monitoring the propagation of the vibration. The computer-implemented method includes identifying one or more points of interest based on the identified changes in the vibration amplitudes. The monitoring and identification of the points of interest in the machine where vibration changes occur enable targeted interventions to mitigate adverse effects caused by vibration.

In some embodiments, the computer-implemented method includes detecting a stress value by the computer based on assessing one or more stress levels in at least one component of the machine, where the stress levels are induced by the propagation of the vibration. The computer-implemented method includes identifying material fatigue in the at least one component and operational failure of the at least one component as a result of the repeated propagation of the vibration during a defined time period, where the material fatigue is identified based on the detected stress value. Detected stress levels and material fatigue in machine components aids in preventing operational failures and extending the lifespan of the machine.

According to some embodiments of the disclosure, the system for switching the position of a dual modality coupling module is described. The system performs a method for switching the position of the dual modality coupling module. The method includes obtaining a vibration level for each of one or more points of interest associated with a machine. The method further includes determining a position of a dual modality coupling module for coupling based on the obtained vibration level and a defined vibration threshold. The determined position is either a mechanical coupling position or a magnetic coupling position. The method includes generating a first signal to switch the dual modality coupling module from the magnetic coupling position to the mechanical coupling position. The first signal is generated in a case where the obtained vibration level fails to satisfy the defined vibration threshold. The method includes generating a second signal to switch the dual modality coupling module from the mechanical coupling position to the magnetic coupling position. The second signal is generated when the obtained vibration level satisfies the defined vibration threshold. The method includes transmitting the generated first signal and the generated second signal to the dual modality coupling module to switch between the mechanical coupling position and the magnetic coupling position. The switch between the mechanical coupling position and the magnetic coupling position is based on the regulation of a current flow in a first set of magnetic coils and a second set of magnetic coils of the dual modality coupling module.

In some embodiments, the method includes determining one or more magnetic parameters of the first set of magnetic coils and the second set of magnetic coils. The first set of magnetic coils is associated with a driving component of the dual modality coupling module, and the second set of magnetic coils is associated with a driven component of the dual modality coupling module. The current flow is regulated based on the one or more magnetic parameters. The precise regulation of current flow in the magnetic coils based on specific magnetic parameters enhances the efficiency and effectiveness of the dual modality coupling module.

In some embodiments, the method further includes determining a damage value based on propagation of the vibration through the machine, and regulating the current flow based on the damage value associated with the machine. Regulation of current thus prevents further damage and extending the operational life of the machine.

In some embodiments, the method includes generating a signal to regulate a strength factor of a magnetic field. The strength factor is regulated based on an adjustment to the current flow through the first set of magnetic coils and the second set of magnetic coils. Regulation of magnetic field strength by regulating current flow allows for more precise control of the dual modality coupling module.

In some embodiments, the method includes transmitting a signal to the first set of magnetic coils and the second set of magnetic coils to activate temporary magnetism. The method includes generating a signal to disengage, via a hydraulic component of the dual modality coupling module, a mechanical coupling shaft of the dual modality coupling module. Activating temporary magnetism and disengaging the mechanical coupling shaft via hydraulic components facilitates smooth transitions between coupling positions.

In some embodiments, the mechanical coupling shaft is one of engaged or disengaged by the hydraulic component, and the mechanical coupling shaft comprises a telescope mechanism to switch between the mechanical coupling position and the magnetic coupling position. Engagement and disengagement of the mechanical coupling shaft renders efficient switching between mechanical and magnetic coupling positions using a telescope mechanism.

In some embodiments, the method includes identifying an impact resulting from the propagation of the vibration on the machine based on the usage of the digital twin model, where the impact corresponds to negative effects of vibrating movements on the components of the machine. The method includes generating a signal to isolate the machine based on the identification of the impact. Isolation of the machine protects the machine from getting damaged when adverse impacts are detected.

Various aspects of the disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

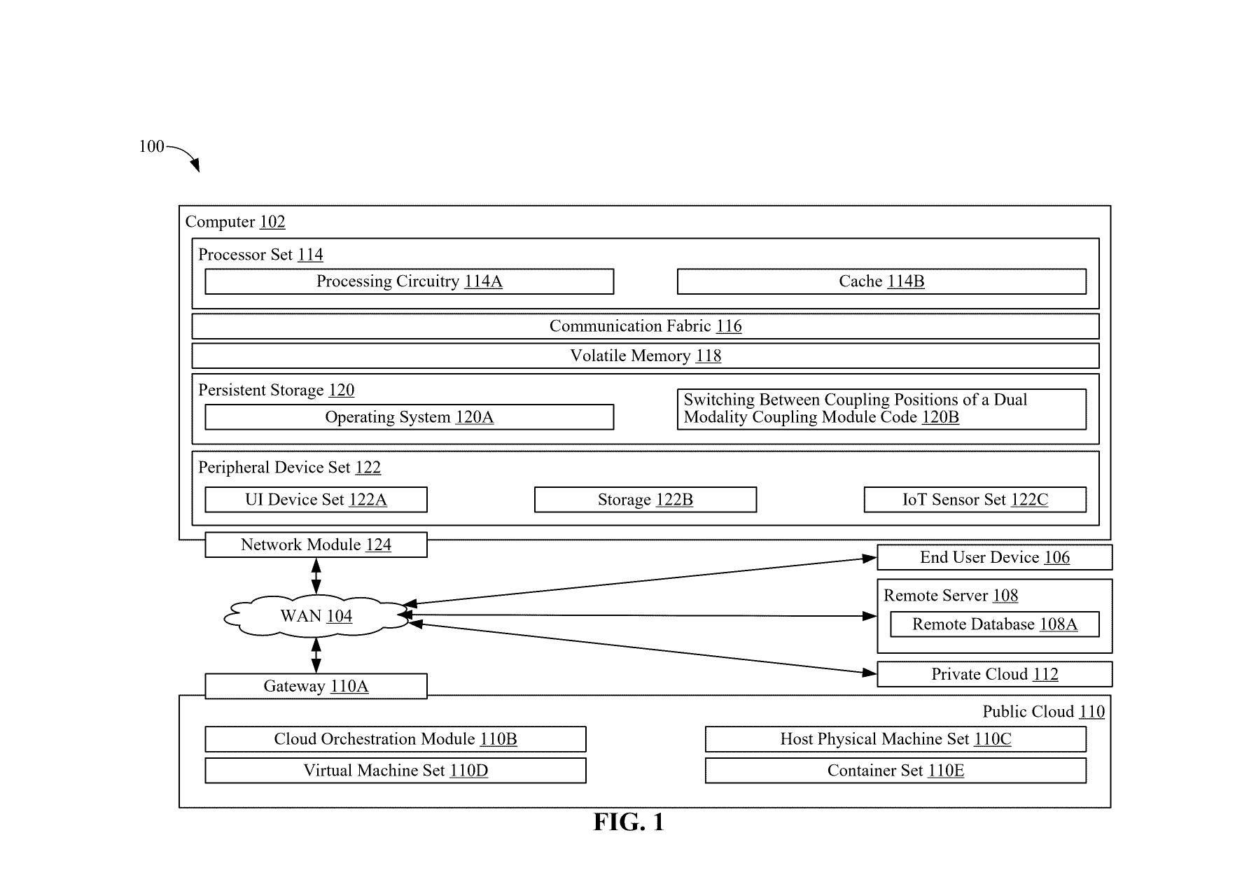

FIG. 1 illustrates a computing environment for switching a position of a dual modality coupling module, in accordance with an embodiment of the disclosure. With reference to FIG. 1, there is shown a computing environment 100 that contains an example of an environment for the execution of at least some of the computer code involved in performing the disclosed methods, such as switching between coupling positions of a dual modality coupling module code 120B. In addition to the switching between coupling positions of the dual modality coupling module code 120B, the computing environment 100 includes, for example, a computer 102, a wide area network (WAN) 104, an end user device (EUD) 106, a remote server 108, a public cloud 110, and a private cloud 112. In some embodiments of the disclosure, the computer 102 includes a processor set 114 (including a processing circuitry 114A and a cache 114B), a communication fabric 116, a volatile memory 118, a persistent storage 120 (including an operating system 120A and the switching between coupling positions of the dual modality coupling module code 120B, as identified above), a peripheral device set 122 (including a user interface (UI) device set 122A, a storage 122B, and an Internet of Things (IOT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch, a robot, or other wearable computer, a mainframe computer, a quantum computer, or any other form of a computer or a mobile device now known or to be developed in the future that is capable of running a program, accessing a network or querying a database, such as a remote database 130. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the other storage media discussed below. The program instructions, and associated data, are accessed by the processor set 114 to control and direct the performance of the disclosed methods. In the computing environment 100, at least some of the instructions for performing the disclosed methods may be stored in the dynamic modification of the switching between coupling positions of the dual modality coupling module code 120B in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to the computer 102, but alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the switching between coupling positions of the dual modality coupling module code 120B typically includes at least some of the computer code involved in performing the disclosed methods.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, the storage 122B may take the form of a quantum computing storage device for storing data in the form of qubits. In some embodiments of the disclosure where the computer 102 is required to have a large amount of storage (for example, where the computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In other embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates the computer 102) and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 130 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows the public cloud 110 to communicate through the WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In some embodiment of the disclosure, the public cloud 110 and the private cloud 112 are both part of a larger hybrid cloud.

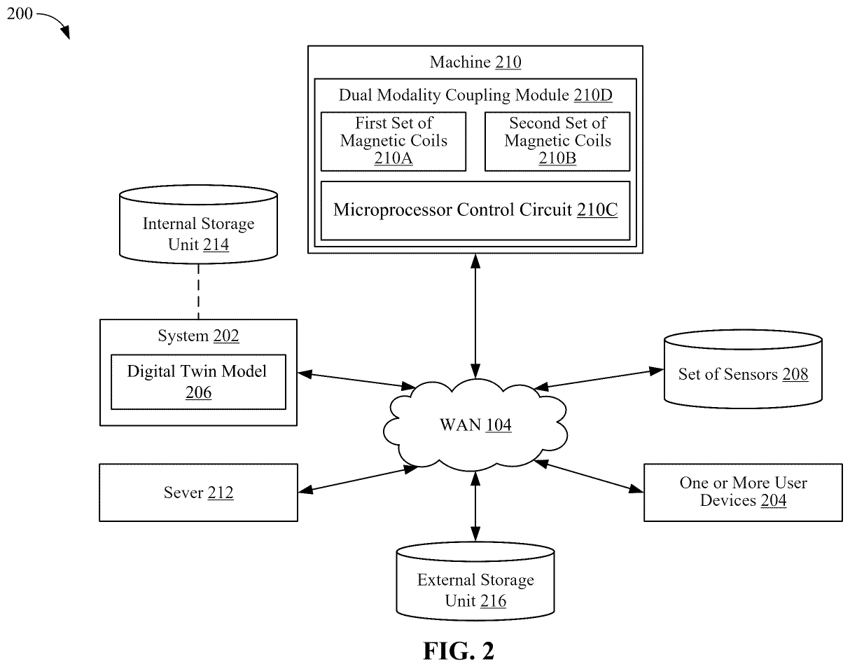

FIG. 2 is a diagram that illustrates an environment for switching the position of the dual modality coupling module, in accordance with an embodiment of the disclosure. FIG. 2 depicts a network environment 200, which includes a system 202, one or more user devices 204, a digital twin model 206, and a set of sensors 208. Additionally, the network environment 200 comprises a machine 210, a server 212, an internal storage unit 214, and an external storage unit 216. Communication among these components is facilitated by the WAN 104.

The system 202 includes suitable logic, circuitry, interfaces, and/or code configured for simulating the propagation of vibrations through the machine 210 using the digital twin model 206. The propagation of vibrations are caused by application of a force on the machine 210. The digital twin model 206 is a virtual replica of the machine 210, enabling simulation and analysis of vibration impacts. The machine 210 is a physical machine implemented at an activity area to perform designated tasks. The activity area refers to a specified zone or environment where the machine 210 is deployed to execute its operational functions. The activity area is defined based on the requirements and nature of the tasks the machine is intended to perform. Examples of the task include, but may not be limited to, drilling, pumping, milling, welding, material handling, cutting, and the like. In one illustration, in a car manufacturing plant, the machine 210 may be positioned in an area where the machine 210 performs tasks, such as welding car frames, drilling holes for components, and handling materials to different assembly stations.

The system 202 obtains data to generate the digital twin model 206 from the set of sensors 208. The set of sensors 208 collects real-time data on vibration levels at various points of interest within the machine 210. The real-time data is processed by the system 202 to determine the necessity of switching between mechanical and magnetic coupling. The set of sensors 208 includes, but may not be limited to, accelerometers, vibration sensors, strain gauges, gyroscopes, and the like. With reference to the illustration of the car manufacturing plant, when a car frame is being welded, accelerometers and vibration sensors implemented on the welding arms may detect any excessive vibrations that could compromise the weld quality. The system 202 processes the data received from the accelerometer and the vibration sensors in real time and triggers a switch from mechanical to magnetic coupling to reduce the impact of vibrations. Similarly, strain gauges on the assembly line frames may detect a value of stress caused by vibrations, prompting the system 202 to act upon for protecting the machine 210 and ensure consistent product quality.

The digital twin model 206 of the system 202, according to the present embodiment, also performs a simulation of an activity area to predict unbalanced force generation and its potential impact on machine vibrations. The system 202 utilizes Internet of Things (IOT) technology and image feeds of the activity area to analyze the surrounding activities.

The system 202 obtains data associated with an activity performed by the machine 210 for the digital twin model 206. The data may be obtained from the set of sensors 208, the internal storage unit 214, and/or the external storage unit 216. The data includes a layout of the activity area, equipment or machines implemented in the activity area, and operational parameters of the machines.

Based on the obtained data, the digital twin model 206 is simulated by the system 202 to generate a behavioural model of the machine 210. The system 202 generates a first model representing geometrical properties and mechanical properties of the machine 210 based on the obtained data. The system 202 further generates a second model representing one or more physical properties of the machine 210 and a plurality of components of the machine 210. The second model is generated based on the obtained data. By accumulating the first model and the second model, the digital twin model 206 is simulated to develop the behavioural model which is a physics-based representation that includes the behaviour of the machine 210 and their components, modelling the mechanical properties, interactions, responses of the equipment to various forces and loads applied to the machine 210, and position of center of gravity.

After generation of the behavioural model, the digital twin model 206 is simulated for generation of a force applied to the machine 210 during the activity. In one implementation, the force can be an unbalanced force. In another implementation, the force can be a balanced force. The present embodiment is described with reference to the unbalanced force. The digital twin model 206 obtains data collected by the set of sensors 208, historical records, or anticipated operational conditions to simulate the generation of unbalanced forces during the activity. These unbalanced forces are applied to the digital twin model 206 to observe their effects on the machine 210.

The system 202, based on application of the unbalanced forces within the digital twin model 206, determines one or more points of interest where unbalanced forces might manifest, such as rotating parts or joints. The one or more points of interest are determined based on the propagation of vibration impacting the machine 210, where the propagation of vibration is a result of the application of the force. The system 202, for simulation, considers data related to the machine 210, such as various component parameters, geometry, material properties, estimated weight, and position of the centre of gravity (GC) with visual analysis and object recognition.

The digital twin model 206 obtains historical records to predict the unbalanced force applied to the machine 210, determining a known pattern of vibration generation and propagation of vibration through the machine 210. The unbalanced force generated in a rotating machine due to a mass imbalance is determined using equation (1):

$$F = m \cdot r \cdot ω2 \qquad ( 1 )$$

where:
F is the unbalanced force in Newtons (N).
m is the mass imbalance in kilograms (kg).
r is the radius at which the mass imbalance is located in meters (m).
ω is the angular velocity of the machine in radians per second (rad/s).

The equation (1) represents the relationship between the unbalanced force, mass imbalance, radius, and angular velocity. The equation (1) assumes a simplified scenario and excludes factors, such as damping, stiffness, and complex vibration modes that may be present in real-world systems. For more accurate determination of unbalanced force generation, in accordance with one aspect of the present embodiment, modelling tools, such as finite element analysis or vibration analysis are utilized by the digital twin model 206.

For predicting a response of the machine 210 to the application of the unbalanced force, the system 202 considers the factors, such as damping and complex vibration modes. Therefore, the system 202 generates a damper model for the machine 210. The damper model facilitates the prediction of dynamic response of the machine 210 to external forces, such as applied unbalanced force. The damper model is based on parameters of the machine 210, including the machine's natural frequency and damping coefficient, which are indispensable for predicting the machine's response to the predicted unbalance force.

The system 202 further determines an impact of the propagation of the vibration on the machine 210, where the impact of the propagation of the vibration corresponds to negative effects of vibrating movements on a plurality of components of the machine 210. The system 202 then identifies one or more vibration frequencies of the machine 210 based on the determined impact and one or more natural frequencies of the machine 210.

The natural frequency typically corresponds to the rotation frequency of the machine 210, defined as the number of revolutions per unit time. By analysing the natural frequency, the system 202 accurately predicts the influence of the unbalance force on the machine's vibrations. The vibration frequencies are the frequencies at which the force causes the impact on the machine 210 at the one or more vibration frequencies. Based on determination that the vibration frequencies match the natural frequencies, a damage value caused by a resonance frequency is determined. Resonance, which can significantly amplify vibrations, is assessed to determine its potential to cause damage. Resonance frequency analysis ensures that risks associated with resonance are identified and mitigated.

If the vibration modes of the machine 210 are known, the system 202 performs a vibration mode analysis. The vibration analysis determines a pattern of various vibration modes getting excited by the predicted unbalance force within the machine 210. By determining which vibration mode might be excited, along with the corresponding frequencies, allows the system 202 to provide precise simulation of the impact of the unbalance force on the machine's operation.

Based on the damping capability and the magnitude of the unbalance force, the system 202 predicts the vibration level at specific points of interest on the machine 210. This prediction is performed using one or more vibration prediction software or analytical methods known in the art. The predicted vibration amplitudes are then compared with acceptable vibration limits specified by industry standards to ensure that the machine 210 operates within safe and efficient parameters.

The system 202 analyses the impact of the generated unbalanced forces resulting in vibrations in the machine components. By simulating the vibration propagation paths, the system 202 identifies potential areas of concern where vibrations might cause operational issues. Such predictive capability ensures that the system 202 can identify potential problems proactively, allowing for pre-emptive maintenance and enhancement of machine.

In order to determine the vibration propagated through the machine 210 and assess the negative effect that the vibration can cause to the machine 210, the digital twin model 206 is simulated. The digital twin model 206 includes detailed geometry, components, materials, and mechanical properties, accurately representing the real-world machine and its behaviour. The digital twin model 206 serves as a virtual replica, ensuring precise simulation of real-world conditions.

The system 202 includes the predicted unbalanced force or other vibration sources into the digital twin model 206 simulation. The unbalanced force is applied to the appropriate location and direction, replicating real-world conditions. The system 202 then observes the propagation of vibration through different components of the machine 210. The simulation monitors the propagation of the vibration through the machine 210 generated because of the application of the unbalanced force to the digital twin model 206. The changes in the vibration amplitudes of the propagated vibration during transmission of the propagated vibration from a source location of the machine 210 to at least one of the target location or the component of the machine 210 are also identified. Based on changes in the vibration amplitude, one or more points of interest where vibrations could potentially cause damage are identified.

The system 202 assesses a value of stress levels induced by the propagated vibrations in various components. The value of stress level is indicative of stress sustained by the machine 210 or the machine components caused by vibration. A material fatigue analysis is performed to identify a material fatigue in the machine component and operational failure of the machine components. The material fatigue analysis evaluates whether vibrations, sustained by the machine 210 and the machine components for a defined time period, could lead to material fatigue or component failure. The material fatigue is identified based on the detected stress value. The fatigue analysis is performed to identify the long-term effects of vibrations on the machine components, ensuring their durability and reliability.

The determined vibration levels are compared with a defined vibration threshold. The defined vibration threshold is an established tolerance limit in accordance with the industry standards. Such comparison determines whether the predicted vibrations can cause damage to the machine 210 or compromise functionality of the machine 210. Based on such determination, a required coupling position for the machine 210 is determined. If the machine 210 is not in the required position, the current coupling position is switched to the required coupling position. For example, if the machine 210 is in mechanical coupling position, and it is determined that the vibration levels can cause damage to the machine 210, the coupling position is switched to the magnetic coupling position.

Referring to FIG. 2, for switching between the mechanical coupling position and the magnetic coupling position, the machine 210 includes a first set of magnetic coils 210A, a second set of magnetic coils 210B, and a microprocessor control circuit 210C. The first set of magnetic coils 210A and the second set of magnetic coils 210B are integral components used to generate magnetic fields, which facilitate magnetic coupling. The first magnetic coil 210A and the second magnetic coil 210B are composed of wound wire that creates a magnetic field when an electric current is passed through them. The microprocessor control circuit 210C manages the activation and deactivation of these magnetic coils based on signals received from the system 202, ensuring precise control of the coupling process.

The internal storage unit 214 and the external storage unit 216 are implemented for storing data related to the digital twin model 206 and operational parameters of the machine 210. The internal storage unit 214 is typically a high-speed storage medium such as a Solid State Drive (SSD) or a Hard Disk Drive (HDD) located within the system 202. The internal storage unit 214 stores data required for real-time processing and simulation. For example, the data collected from the set of sensors 208 is stored in the internal storage unit 214. The external storage unit 216, which may also be an SSD or HDD, serves as a backup and archival storage solution, ensuring data redundancy and long-term data retention. The external storage unit 216 may store a data related to the system 202, such as value of defined vibration threshold, operational parameters, and the like. Both storage units i.e., the internal storage unit 214 and the external storage unit 216 are configured for maintaining data integrity and accessibility for ongoing operations and simulations.

The server 212 functions as a central repository for historical data and provides the computational resources to run the digital twin simulations. This server is equipped with high-performance processors, extensive memory, and large storage capacities to handle the computational demands of simulating mechanical operations and analysing vibration impacts. The historical data refers to the accumulated information about past operations, performance metrics, and vibration patterns of the machine 210. The server 212 includes high-performance processors, such as multi-core Central Processing Units and Graphics Processing Units, to efficiently execute algorithms and simulations. The server 212 is also equipped with a memory, including Random Access Memory (RAM) capacities, to facilitate the rapid processing of large datasets. Additionally, the server has substantial storage capacities, utilizing SSDs or HDDs, to store the historical data and the results of the simulations.

The historical data includes records of previous tasks performed by the machine 210, the corresponding vibration levels, the conditions under which these vibrations occurred, and the outcomes of coupling switches between mechanical and magnetic modes. Such data is utilized for training the digital twin model 206, as such data enables the system 202 to predict behaviours of the machine 210 based on past behaviour. By leveraging historical data, the system 202 can enhance the accuracy of its simulations and improve decision-making processes.

The one or more user devices 204 provide interfaces for users to interact with the system 202, monitor the status of the machine 210, and receive recommendations on switching between mechanical and magnetic coupling. These user devices can include computers, tablets, or smartphones that are connected to the WAN 104, enabling remote access and control.

The WAN 104 facilitates seamless communication between the various elements of the network environment 200. The WAN 104 ensures efficient data transfer and coordination among the system 202, the set of sensors 208, the machine 210, the internal storage unit 214, the external storage unit 216, the server 212, and the user devices 204. This integrated environment enables the proactive management of vibration impacts, thereby enhancing the reliability and performance of the machine 210.

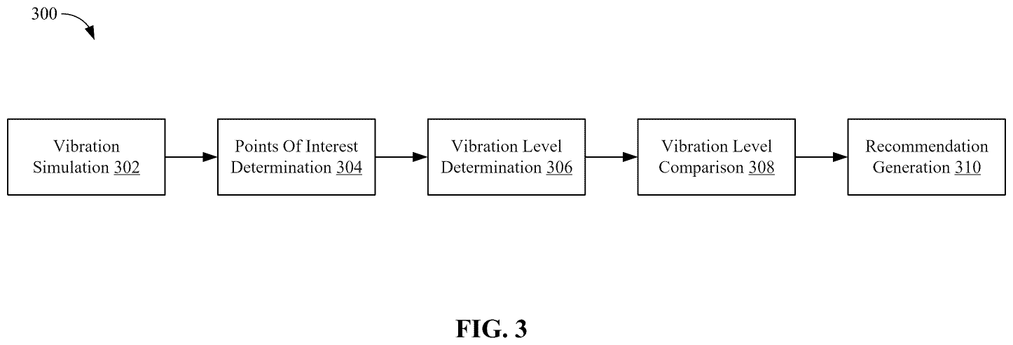

FIG. 3 is a flow chart that illustrates exemplary operations for recommending the use of dual modality coupling module, in accordance with an embodiment of the disclosure. FIG. 3 is explained in conjunction with elements from FIG. 1 and FIG. 2. With reference to FIG. 3, there is shown a block diagram 300 that illustrates exemplary operations from 302 to 310, as described herein. The exemplary operations illustrated in the block diagram 300 may start at 302 and may be performed by any computing system, apparatus, or device, such as by the computer 102 of FIG. 1 or the system 202 of FIG. 2. Although illustrated with discrete blocks, the exemplary operations associated with one or more blocks of the block diagram 300 may be divided into additional blocks, combined into fewer blocks, or eliminated, depending on the particular implementation.

At step 302, a vibration simulation operation is performed. In the vibration simulation operation, the system 202 is configured to simulate the propagation of vibration through the machine 210. The propagation of the vibration results from the application of a force on the machine 210. The simulation is based on the digital twin model 206, which represents a virtual replica of the machine 210. The digital twin model 206 includes data, such as the machine's layout, equipment, and operational parameters, and generates models representing the geometrical, mechanical, and physical properties of the machine 210. The force may be unbalanced force. Unbalanced forces occur when the magnitude of forces acting on the machine 210 is not equal, leading to a net force that causes a change in the motion or vibration of the machine 210. These forces can result from various operational factors, such as uneven loads, sudden impacts, or varying resistance during machine operations. Unbalanced forces are a primary cause of vibrations in the machine 210, which can lead to mechanical wear, noise, and potential damage if not properly managed. In the illustration of the car manufacturing plant, during the welding process, an unbalanced force might occur due to an uneven application of welding pressure, causing the machine 210 to vibrate and potentially impacting the precision of the weld.

At step 304, a points of interest determination operation is performed. Following the simulation at step 302, one or more points of interest are determined, at step 304. In the points of interest determination operation, the system 202 is configured to identify points within the machine 210 where vibration levels are to be monitored. These points of interest are selected based on their susceptibility to vibration-induced damage or their relevance to the machine's operation. Examples of points of interest include bearings, joints, and motor mounts.

At step 306, a vibration level determination operation is performed. In the vibration level determination operation, the system 202 is configured to determine the vibration level at the identified one or more points of interest based on the simulated propagation of the vibration. Determination of the vibration level includes predicting response of the machine 210 response to the applied force, generating a damper model based on natural frequency of the machine 210 and damping coefficient, and calculating the vibration levels at the points of interest. The prediction of response of the machine 210 to the applied force includes analysing reaction of different components of the machine 210 to the force. The force includes both balanced and unbalanced forces. Balanced forces are those where all the forces acting on the machines 210 are equal and opposite, resulting in no net movement. Unbalanced forces, on the other hand, occur when the forces acting on the machine 210 are not equal, causing the machine 210 to move or vibrate.

A damper model is generated to represent energy dissipation of the machine 210 caused due to the vibrations. The natural frequency of the machine 210 is the frequency at which the machine 210 naturally oscillates when disturbed. The damping coefficient is a measure of oscillations decay over time. A higher damping coefficient means that the vibrations may decay faster, while a lower damping coefficient means that the vibrations will persist for a longer period.

To determine the vibration levels at the points of interest, the damper model is used to simulate the machine's response to the applied force. The digital twin model 206 considers the material properties, geometry, and interaction of different components of the machine 210 for simulation. The vibration levels are then calculated based on the simulated response of the digital twin model 206. The simulation represents a behavioural model of the machine 210 representing operational behaviour of the machine 210 under different conditions.

At step 308, a vibration level comparison operation is performed. In the vibration level comparison operation, the system 202 is configured to perform a comparison between the vibration level and a predefined threshold. In some embodiments, the system is configured to compare the measured or simulated vibration levels against defined vibration thresholds that define acceptable vibration limits. The defined vibration thresholds are set based on industry standards, machine specifications, or historical data.

At step 310, a recommendation generation operation is performed. In the recommendation generation operation, the system 202 is configured to generate a recommendation based on the vibration level of the one or more points of interest. In particular, the recommendation is based on the result of vibration level comparison operation. If the vibration levels at any point of interest satisfy the predefined thresholds, the system generates a recommendation to use the dual modality coupling module 210D. The recommendation aims to mitigate the adverse effects of vibrations, ensuring the protection and efficient performance of the machine 210. The recommendation is communicated to the microprocessor control circuit, which manages the coupling transition.

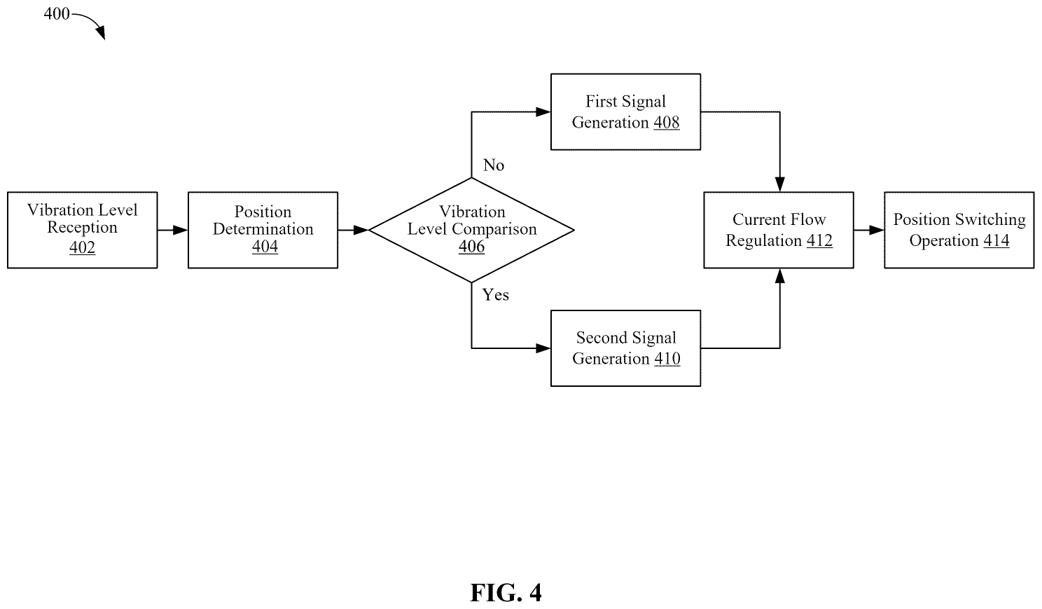

FIG. 4 is a flow chart that illustrates exemplary operations for switching the position of the dual modality coupling module, in accordance with an embodiment of the disclosure. FIG. 4 is explained in conjunction with elements from FIG. 1, FIG. 2, and FIG. 3. With reference to FIG. 4, there is shown a block diagram 400 that illustrates exemplary operations from 402 to 414, as described herein. The exemplary operations illustrated in the block diagram 400 may start at 402 and may be performed by any computing system, apparatus, or device, such as by the computer 102 of FIG. 1 or the system 202 of FIG. 2. Although illustrated with discrete blocks, the exemplary operations associated with one or more blocks of the block diagram 400 may be divided into additional blocks, combined into fewer blocks, or eliminated, depending on the particular implementation.

At step 402, a vibration level reception operation is performed. In the vibration level receival operation, the system 202 is configured to obtain a vibration level for each of one or more points of interest associated with a machine 210. The points of interest are identified based on their susceptibility to vibration-induced damage or their relevance to the operation of machine 210.

At step 404, a position determination operation is performed. In the position determination operation, the system 202 is configured to determine, based on the usage of the digital twin model 206, a position of the dual modality coupling module 210D for coupling based on the obtained level of the vibration and a defined vibration threshold. In an exemplary embodiment of the present disclosure, the determined position is a mechanical coupling position or a magnetic coupling position.

At step 406, a vibration level comparison operation is performed. In the vibration level comparison operation, the system 202 is configured to compare the obtained vibration levels against defined thresholds that define acceptable vibration limits. These thresholds are set based on industry standards, machine specifications, historical data, or any combination thereof.

At 408, a first signal generation operation is performed. If the obtained vibration level fails to satisfy the defined vibration threshold, the first signal generation is executed, at step 408. In the first signal generation operation, the system 202 is configured to generate a first signal to switch the dual modality coupling module 210D from the magnetic coupling position to the mechanical coupling position.

Conversely, if the obtained vibration level satisfies the defined vibration threshold, a second signal generation operation is performed, at step 410. In the second signal generation operation, the system 202 is configured to generate a second signal to switch the dual modality coupling module 210D from the mechanical coupling position to the magnetic coupling position.

Upon generation of either the first signal, as described at 408, or the second signal, as described at 410, a current flow regulation operation 412 is performed. In the current flow regulation operation 412, the system 202 is configured to regulate the current flow in the first set of magnetic coils 210A and the second set of magnetic coils 210B of the dual modality coupling module 210D based on the generated signal. For example, if the first signal is generated, the current flow is reduced to deactivate the magnetism induced in the dual modality coupling module 210, in order to switch from the magnetic coupling position to the mechanical coupling position. The regulation of current flow ensures the proper activation or deactivation of magnetic fields required for switching between coupling positions.

As a result of the regulated current flow, a position switching operation is performed, at step 414. In the position switching operation, the system 202 is configured to transmit the generated signal to the dual modality coupling module 210D to switch between the mechanical coupling position and the magnetic coupling position. The switch is performed based on the regulation of the current flow in the first magnetic coil 210A and the second magnetic coil 210B. The switching process results in managing the vibration impacts on the machine 210, thereby ensuring efficient performance and protection of its components.

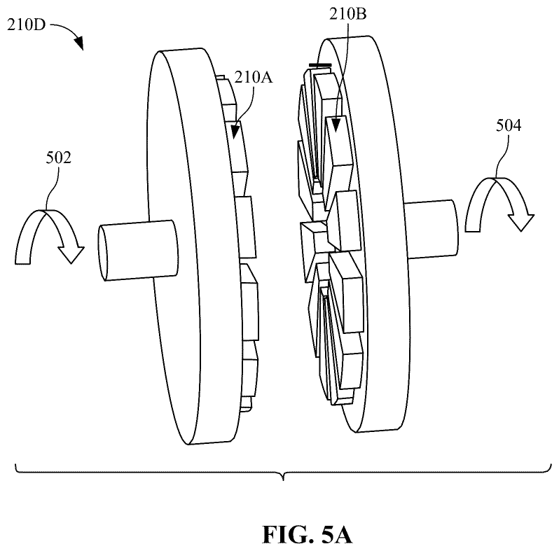

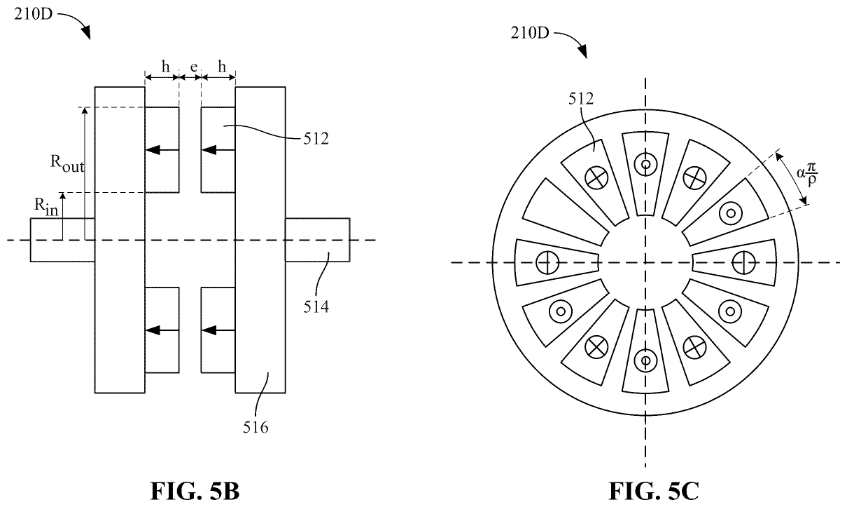

FIG. 5A illustrates a side view of a dual modality coupling module 210D configuration, in accordance with an embodiment of the disclosure. FIG. 5A is explained in conjunction with elements from FIG. 1, FIG. 2, FIG. 3, and FIG. 4. With reference to FIG. 5A, there is shown a diagram that depicts the configuration of the magnetic coupling.

The dual modality coupling module 210D includes dual mode coupling positions, mechanical coupling, and the magnetic coupling. The dual modality coupling module 210D is formed with a physical jaws-based coupling configuration and magnetic coil-based coupling configuration. When a temporary magnetism is created, the magnetic coupling position is activated. In absence of the electric current, the temporary magnetism is deactivated, and the mechanical coupling position is activated.

The magnetic coupling configuration consists of a driving component 502, a first set of magnetic coils 210A, a second set of magnetic coils 210B, and a driven component 504. The driving component 502, typically connected to a motor, generates the initial rotational motion and torque required for the machine's operation. The driving components are the parts of a machine that generate and supply the initial energy required to perform work. The driving components are typically responsible for producing motion, power, or force that is then transferred to other parts of the machine 210. Driven components are the parts of a machine that receive energy from the driving components and utilize it to perform specific tasks. The driven components are typically the end points where the energy is converted into useful work. The first set of magnetic coils 210A and the second set of magnetic coils 210B (hereinafter collectively referred to as magnetic coils 210A, 210B) are configured to generate magnetic fields required for magnetic coupling. The magnetic coils 210A, 210B are positioned coaxially to ensure efficient transmission of torque without physical contact.

The first set of magnetic coils 210A is associated with the driving component 502, while the second set of magnetic coils 210B is associated with the driven component 504. The interaction between the magnetic coils 210A, 210B creates a magnetic field that facilitates the transfer of rotational motion and torque from the driving component 502 to the driven component 504. The driven component 504 is typically connected to the load, which may include various machine components such as pumps, mixers, or other mechanical parts.

The system 202 is configured to determine one or more magnetic parameters of the first set of magnetic coils 210A and the second set of magnetic coils 210B. The current flow is regulated based on the determined one or more magnetic parameters. The one or more magnetic parameters refer to specific characteristics and properties related to the magnetic coils and their operation. Examples of the one or more magnetic parameters include magnetic field, magnetic flux density, magnetic permeability, coil inductance, coil resistance and the like.

The magnetic coupling operates by utilizing the magnetic force of permanent magnets to connect the driving component and the driven component. Unlike traditional couplings that require direct mechanical connections, the magnetic coupling uses magnetic fields to transmit mechanical energy. Such configuration allows the magnetic field to penetrate a certain spatial distance and the characteristics of material materials to transfer mechanical energy efficiently.

The structure of the magnetic coupling enables the transmission of force and torque between the driving shaft and the driven shaft without direct contact, effectively transforming dynamic seals into static seals, thereby achieving zero leakage.

The switching between coupling positions is managed by regulating the current flow in the magnetic coils 210A, 210B. The current flow regulation ensures the proper strength of the magnetic field required for effective coupling. First, a damage value, which represents magnitude of the damage, is determined based on propagation of the vibration through the machine 210. Then, the current flow is regulated based on the damage value associated with the machine 210. For example, if the propagation of vibration is determined to be higher, the damage value will be higher. To prevent the potential damage, the higher current may be supplied to induce stronger magnetic field. The strength factor of the magnetic field can be regulated by generating a signal, by the processor set 114, for the microprocessor control circuit 210C. The strength factor is based on an adjustment of the current flow through the first set of magnetic coils 210A and the second set of magnetic coils 210B.

The processor set 114 is configured to switch between the mechanical coupling position and the magnetic coupling position by transmitting a signal to the first set of magnetic coils 210A and the second set of magnetic coils 210B to activate temporary magnetism. The signal is received by the microprocessor control circuit 210C, which regulates the current in the magnetic coils. Additionally, the processor set 114 generates a signal to the microprocessor control circuit 210C to deactivate the temporary magnetism and switch back to the mechanical coupling position. Engagement or disengagement of the mechanical coupling is performed by a hydraulic component.

The mechanical coupling shaft, which is either engaged or disengaged by the hydraulic component, includes a telescope mechanism that facilitates switching between the mechanical coupling position and the magnetic coupling position. The telescope mechanism is a type of mechanical structure that can extend and retract, similar to the operation of a telescope. It allows for precise alignment and engagement or disengagement of the mechanical coupling shaft.

The hydraulic component consists of a hydraulic actuator, a pump, and a control valve. The hydraulic actuator is responsible for generating the required force to engage or disengage the mechanical coupling shaft. The pump supplies hydraulic fluid under pressure, while the control valve regulates the flow of hydraulic fluid to the actuator based on signals from the system 202.

When the system 202 determines the need to switch from the mechanical coupling position to the magnetic coupling position, the system 202 sends a signal to the control valve. This signal causes the control valve to direct hydraulic fluid to the actuator, which then moves the mechanical coupling shaft to the disengaged position. The telescope mechanism within the shaft allows it to retract smoothly, ensuring a precise disengagement.

When it is determined by the system 202 to switch back to the mechanical coupling position, the system 202 sends a signal to the control valve to reverse the flow of hydraulic fluid. The actuator then extends the mechanical coupling shaft, using the telescope mechanism to ensure accurate alignment and engagement with the mechanical components.

In one aspect, the system 202 identifies an impact caused by propagation of the vibration on the machine 210 based on usage of the digital twin model 206. The impact of the propagation of the vibration corresponds to negative effects of vibrating movements on a plurality of components of the machine 210. For example, the impact can be a damage force causing malfunctioning of the components. In another example, the impact can be a destructive force causing total destruction of the components. In the event of identification of the impact having such negative effects, the system 202 generates a signal to isolate the machine 210. The machine 210 is isolated from the power causing total or partial shut-down of the machine 210. The isolation measures may also include deactivating or reducing the operation of affected components, reconfiguring operational parameters to mitigate vibration effects, and activating additional dampening mechanisms. Because of the isolation, the machine 210 can be protected from the negative effects of the vibration propagation.

FIG. 5B is a diagram showing a cross-sectional side view of the dual modality coupling module configuration. The dual modality coupling module configuration comprises a mechanical coupling shaft 514, referred as to the shaft 514, which serves as the axis for rotational motion. The first set of magnetic coils 210A is positioned on one side of the shaft 514, while the second set of magnetic coils 210B is positioned on the opposite side. Each set of magnetic coils 210A, 210B include a set of magnets 512. The magnets conduct temporary magnetism induced by the current flow. Each magnet of the set of magnets 512 is formed with an inner edge and an outer edge. Rᵢₙ represents the inner radius of the magnetic coils. Rᵢₙ is the distance from the center of the shaft 514 to the inner edge of the magnets. Rₒᵤₜ represents the outer radius of the magnetic coils 210A, 210B. Rout is the distance from the center of the shaft 514 to the outer edge of the magnets 512. Rₒᵤₜ defines the outer boundary of the area where the magnets 512 are positioned. Height of the magnets 512, h, represents the height or thickness of the magnets 512 used in the dual modality coupling module 210D. h is the distance between the top and bottom surfaces of the magnets. Air gap, e, represents the air gap between the two sets of magnets in the magnetic coupling system. The air gap is the distance between the facing surfaces of the magnets on the two coupling halves. The air gap determines the magnetic coupling efficiency.

The magnetic coils 210A, 210B work in tandem to generate a magnetic field that facilitates the non-contact transmission of torque. Additionally, a soft iron yoke 516 is implemented to enhance the efficiency of magnetic coupling by directing the magnetic field lines effectively.

FIG. 5C shows the front view of the dual modality coupling module configuration. FIG. 5C illustrates the arrangement of magnets 512 around the circumference of the dual modality coupling module 210D as described in FIG. 5B. The magnets 512 are integral components of the magnetic coils 210A, 210B shown in FIG. 5A required for producing the magnetic fields required for coupling. FIG. 5C also illustrate the angle, α. The angle between magnets, α, represents the maximum angular length of each magnet 512. α is measured at an outer edge of the magnets 512 around the circumference of the set of magnetic coils (210A, 210B). α represent the magnets spacing relative to each other in the circular arrangement

The modality coupling module configuration operates by switching between mechanical and magnetic coupling based on the vibration levels detected in the machine 210. The processor set 114 generates signals to regulate the current flow through the magnetic coils, thereby controlling the activation and deactivation of the magnetic fields. Such dynamic switching ensures efficient performance and protection of the machine components by mitigating the adverse effects of vibrations.

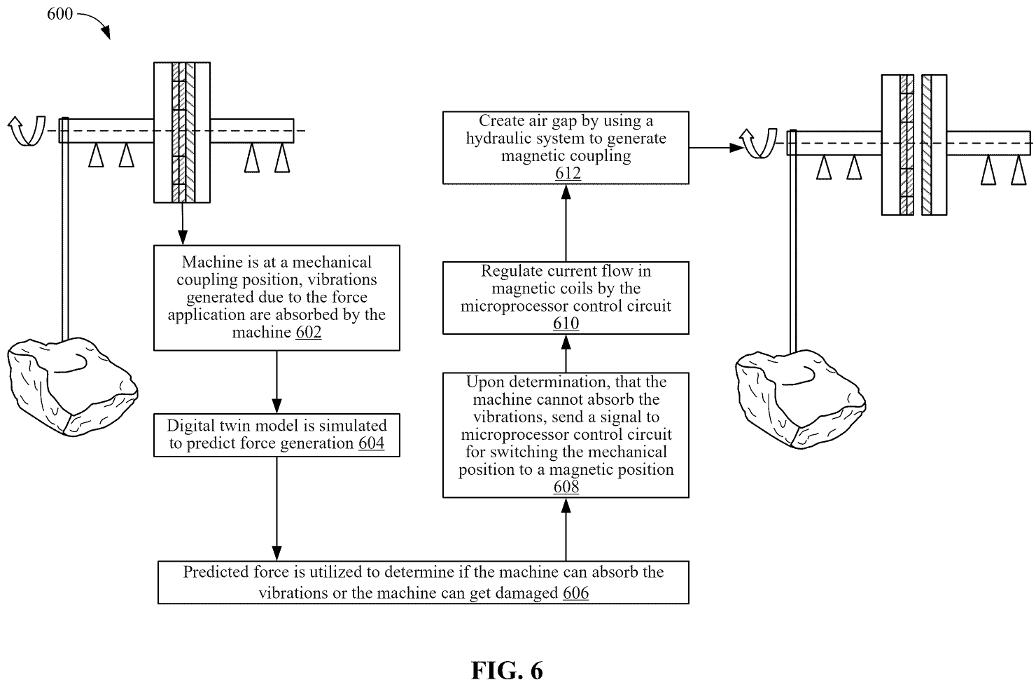

FIG. 6 is diagram of a process 600 of contextual switching of coupling positions of the dual modality coupling module 210D based on the outcome of digital twin simulation, in accordance with an embodiment of the disclosure. FIG. 6 is explained in conjunction with elements from FIG. 1, FIG. 2, FIG. 3, FIG. 4, and FIG. 5A-FIG. 5C.

At 602, the process of contextual switching is initiated when the machine 210 is in the mechanical coupling position. The machine 210 is positioned at the mechanical coupling position when the machine 210 is able to absorb the generated unbalanced force.

At 604, the digital twin model 206 is simulated to predict the force generation, as described in FIG. 2. The digital twin model 206 includes various parameters of the machine 210 to accurately forecast the impact of applied forces, thus providing a detailed analysis of potential vibration impacts. In one example, the parameters are magnetic parameters, such as magnetic field strength, magnetic flux density, magnetic permeability, coil inductance, coil resistance and the like.

At 606, a determination is made, by using the predicted forces, if the machine 210 is able to absorb the vibrations, as described in FIG. 2. If the simulation indicates that the machine 210 cannot effectively manage the predicted vibrations, there is a risk of damage to the machine components.

Upon determining that the machine 210 cannot absorb the vibrations, at 608, a signal is sent, by the system 202, to the microprocessor control circuit 210C for switching the machine 210 from the mechanical coupling position to a magnetic coupling position, as described in FIG.

2. This transition is performed to mitigate the risk of damage by switching to a non-contact method of torque transmission.

At 610, the current flow in the magnetic coils is regulated by the microprocessor control circuit 210C, as described in FIG. 2. The current flow regulation ensures the magnetic field generated is appropriate for effective magnetic coupling and torque transmission, without having to establish a physical contact.

At 612, an air gap is created using a hydraulic system to generate magnetic coupling, as described in FIG. 5. The hydraulic system ensures that the mechanical components are separated, allowing the magnetic field to facilitate torque transmission without direct physical contact, thereby reducing wear and preventing damage from vibrations.

The contextual switching of coupling positions in the machine 210 based on the outcome of digital twin simulation, performed by the system 202, may provide advantages of delivering efficient performance and protection of machine components. The system 202 accurately predicts and manages unbalanced forces and vibrations, thereby mitigating adverse effects and enhancing machine reliability. The dynamic activation and deactivation of magnetic fields, performed by the system 202, renders seamless transitions between coupling positions and prevents vibration propagation to sensitive components. Real-time vibration assessment ensures the machine 210 operates within safe vibration limits and preventing potential damage. The system 202 enhances the overall reliability and longevity of the machine 210, reducing maintenance needs and operational disruptions.

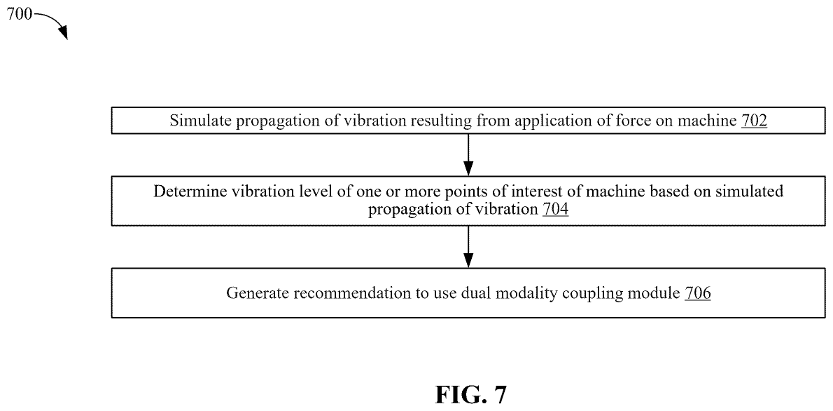

FIG. 7 is a flow chart illustrating a computer-implemented method 700 for determining a required coupling position of the dual modality coupling based on an outcome of digital twin model simulation, in accordance with an embodiment of the disclosure.

At 702, a simulation of propagation of vibration through the machine 210 is performed, as described in FIG. 2. The propagation of the vibration results from the application of a force on the machine 210, and the simulation is based on the digital twin model 206. At 702, a virtual representation of the machine 210 and the components of the machine 210 is created to accurately model the physical behavior under various operational conditions, as described in FIG. 2 and FIG. 3.

At 704, a determination of a vibration level for one or more points of interest of the machine 210 is made based on the simulated propagation of vibration. The simulation data is analyzed to identify areas within the machine 210 that experience significant vibrations, which could potentially lead to mechanical stress or damage, as described in FIG. 2.

At 706, a recommendation to use the dual modality coupling module 210D is generated. The recommendation is generated based on a determination that the vibration level for the one or more points of interest satisfies the defined vibration threshold. The vibration levels are evaluated against predefined safety or operational thresholds and recommending the use of a coupling module that switches between mechanical and magnetic coupling to mitigate the impact of excessive vibrations.

While the above steps shown in FIG. 7 are described in a particular sequence, the steps may occur in variations to the sequence in accordance with various embodiments of the present disclosure. Further, details related to various steps of FIG. 7, which are already covered in the description related to FIG. 1 to FIG. 6 are not discussed again in detail here for the sake of brevity.

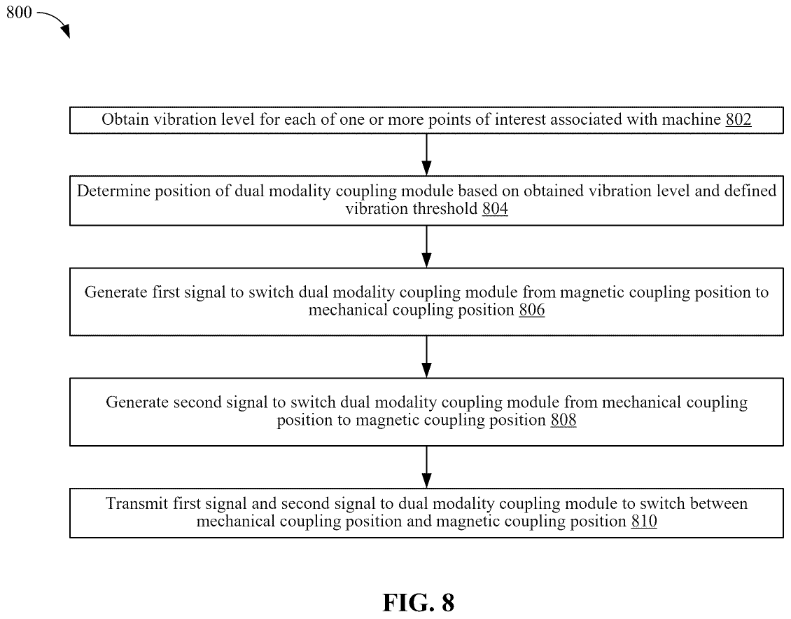

FIG. 8 is a flow chart illustrating a method 800 for switching coupling positions of the dual modality coupling module, in accordance with an embodiment of the disclosure.

At 802, a vibration level for each of one or more points of interest associated with the machine 210 is obtained, as described in FIG. 2. The vibration levels are measured at various points in the machine 210 to assess the extent of vibrations affecting the components of the machine 210.

At 804, a position of the dual modality coupling module 210D is determined for coupling based on the obtained vibration level and a defined vibration threshold, as described in FIG. 2. The position of the dual modality coupling is determined based on the outcome of the digital twin model 206. The digital twin model 206 simulates the machine's behavior under different operating conditions and helps in identifying whether the coupling should be in a mechanical position or a magnetic position, as described in FIG. 2 and FIG. 3.

At 806, a first signal is generated to switch the dual modality coupling module 210D from the magnetic coupling position to the mechanical coupling position. The first signal is generated based on the determination that the obtained vibration level fails to satisfy the defined vibration threshold, as described in FIG. 4. When vibration levels are within acceptable limits of the defined vibration threshold, the system 202 defaults to mechanical coupling for efficient power transmission.

At 808, a second signal is generated to switch the dual modality coupling module 210D from the mechanical coupling position to the magnetic coupling position. The second signal is generated when the obtained vibration level satisfies the defined vibration threshold, as described in FIG. 4. The magnetic coupling position is activated to minimize the impact of excessive vibrations on the machine components.

At 810, the generated first signal or the generated second signal is sent to the dual modality coupling module 210D to switch between either the mechanical coupling position or the magnetic coupling position. Such transition is managed by regulating the current flow in the first set of magnetic coils 210A and the second set of magnetic coils 210B of the dual modality coupling module 210D, ensuring a smooth and effective switch between coupling positions.

While the above steps shown in FIG. 8 are described in a particular sequence, the steps may occur in variations to the sequence in accordance with various embodiments of the present disclosure. Further, details related to various steps of FIG. 8, which are already covered in the description related to FIG. 1 to FIG. 7 are not discussed again in detail here for the sake of brevity.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
simulating, by a computer, propagation of vibration resulting from application of a force on a machine, wherein the simulating is based on a digital twin model;
determining, by the computer, a vibration level of one or more points of interest of the machine based on the simulated propagation of the vibration; and
generating, by the computer, a recommendation to use a dual modality coupling module, wherein the recommendation is generated based on the vibration level of the one or more points of interest.

2. The computer-implemented method of claim 1, wherein the simulating the propagation of the vibration through the machine based on the digital twin model comprises:
obtaining, by the computer, data associated with an activity performed by the machine, wherein the data comprises at least one of a layout, an equipment, or operational parameters associated with the machine;
generating, by the computer, a first model representing geometrical properties and mechanical properties of the machine based on the obtained data;
generating, by the computer, a second model representing one or more physical properties of the machine and a plurality of components of the machine, wherein the second model is generated based on the obtained data; and
simulating, by the computer, the digital twin model based on the first model and the second model.

3. The computer-implemented method of claim 2, wherein the second model represents material properties of the plurality of components, interaction responses observed between the plurality of components, responses from components to the force, loads applied to the machine, and position of center of gravity.

4. The computer-implemented method of claim 1, further comprising:
predicting, by the computer, a response of the machine based on the application of the force, wherein the response of the machine is predicted based on generation of a damper model, and wherein the damper model is based on a natural frequency of the machine and a damping coefficient of the machine; and
determining, by the computer, the vibration level at the one or more points of interest associated with the machine, wherein the vibration level is determined based on the damper model and a magnitude of the force.

5. The computer-implemented method of claim 1, further comprising:
determining, by the computer, an impact of the propagation of the vibration on the machine, wherein the impact of the propagation of the vibration corresponds to negative effects of vibrating movements on a plurality of components of the machine;
identifying, by the computer, one or more vibration frequencies of the machine based on the determined impact, wherein the force causes the impact on the machine at the one or more vibration frequencies;
identifying, by the computer, one or more natural frequencies of the machine; and
determining, by the computer, damage value caused by a resonance frequency based on the determination that the one or more natural frequencies match with the one or more vibration frequencies.

6. The computer-implemented method of claim 5, further comprising:
applying, by the computer, the force to the digital twin model;
monitoring, by the computer, the propagation of the vibration caused by the force at the digital twin model, wherein the force is applied through at least one of a target location of the machine or a component of the machine;
identifying, by the computer, changes in vibration amplitudes of the propagated vibration during transmission of the propagated vibration from a source location of the machine to at least one of the target location or the component of the machine, wherein the changes in the vibration amplitudes is identified based on the monitoring of the propagation of the vibration; and
identifying, by the computer, the one or more points of interest based on the identified changes in the vibration amplitudes.

7. The method of claim 1, further comprising:
detecting, by the computer, a stress value based on assessing one or more stress levels in at least one component of the machine, wherein the one or more stress levels are induced by the propagation of the vibration; and
identifying, by the computer, a material fatigue in the at least one component and operational failure of the at least one component, as a result of the propagation of the vibration repeated during a defined time period, wherein the material fatigue is identified based on the detected stress value.

8. A system, comprising:
a processor set configured to:
obtain a vibration level for each of one or more points of interest associated with a machine,
determine a position of a dual modality coupling module based on the obtained vibration level and a defined vibration threshold, wherein the determined position is one of a mechanical coupling position or a magnetic coupling position;
generate a first signal to switch the dual modality coupling module from the magnetic coupling position to the mechanical coupling position, wherein the first signal is generated in a case where the obtained vibration level fails to satisfy the defined vibration threshold;
generate a second signal to switch the dual modality coupling module from the mechanical coupling position to the magnetic coupling position, wherein the second signal is generated in a case where the obtained vibration level satisfies the defined vibration threshold; and
transmit the first signal and the second signal to the dual modality coupling module to switch between the mechanical coupling position and the magnetic coupling position, wherein the switch between the mechanical coupling position and the magnetic coupling position is based on a regulation of a current flow in a first set of magnetic coils and a second set of magnetic coils of the dual modality coupling module.

9. The system of claim 8, wherein the processor set is further configured to determine one or more magnetic parameters of the first set of magnetic coils and the second set of magnetic coils, the first set of magnetic coils is associated with a driving component of the dual modality coupling module, the second set of magnetic coils associated with a driven component of the dual modality coupling module, and wherein the current flow is regulated based on the one or more magnetic parameters.

10. The system of claim 8, wherein the processor set is further configured to:
determine a damage value based on propagation of the vibration through the machine, and
regulate the current flow based on the damage value associated with the machine.

11. The system of claim 8, wherein the processor set is further configured to:
generate a signal to regulate a strength factor of a magnetic field, wherein the strength factor is regulated based on an adjustment of the current flow through the first set of magnetic coils and the second set of magnetic coils.

12. The system of claim 8, wherein, to switch between the mechanical coupling position and the magnetic coupling position, the processor set is further configured to:
transmit a signal to the first set of magnetic coils and the second set of magnetic coils to activate temporary magnetism; and
generate a signal to disengage, via a hydraulic component of the dual modality coupling module, a mechanical coupling shaft of the dual modality coupling module.

13. The system of claim 12, wherein the mechanical coupling shaft is one of: engaged or disengaged by the hydraulic component, and wherein the mechanical coupling shaft comprises a telescope mechanism to switch between the mechanical coupling position and the magnetic coupling position.

14. The system of claim 8, wherein the processor is further configured to:
identify an impact caused by propagation of the vibration on the machine based on usage of the digital twin model, wherein the impact of the propagation of the vibration corresponds to negative effects of vibrating movements on a plurality of components of the machine; and
generate a signal to isolate the machine based on the identification of the impact.

15. A computer program product for switching a position of a dual modality coupling module, the computer program product comprising a computer-readable storage medium having program instructions embodied therewith, the program instructions executable by a system to cause the system to:
obtain a vibration level for each of one or more points of interest associated with a machine;
determine a position of a dual modality coupling module based on the obtained level of the vibration and a defined vibration threshold, wherein the determined position is one of a mechanical coupling position or a magnetic coupling position;
generate a first signal to switch the dual modality coupling module from the magnetic coupling position to the mechanical coupling position, wherein the first signal is generated in a case where the obtained vibration level fails to satisfies the defined vibration threshold;
generate a second signal to switch the dual modality coupling module from the mechanical coupling position to the magnetic coupling position, wherein the second signal is generated when the obtained vibration level satisfies the defined vibration threshold; and
transmit the generated first signal and the generated second signal to the dual modality coupling module to switch between the mechanical coupling position and the magnetic coupling position, wherein the switch between the mechanical coupling position and the magnetic coupling position is based on regulating a current flow in a first set of magnetic coils and a second set of magnetic coils of the dual modality coupling module.

16. The computer program product of claim 15, wherein the program instructions executable by the system to cause the system to:
determine one or more magnetic parameters of the first set of magnetic coils and the second set of magnetic coils, the first set of magnetic coils is associated with a driving component, the second set of magnetic coils associated with a driven component of the dual modality coupling module, wherein the current flow is regulated based on the one or more magnetic parameters.

17. The computer program product of claim 15, wherein the regulation of the current flow is based on a damage value associated with the machine, and wherein the damage value is calculated based on propagation of the vibration through the machine.

18. The computer program product of claim 15, wherein the program instructions executable by the system to cause the system to:
generate a signal to regulate a strength factor of a magnetic field, wherein the strength factor is regulated based on an adjustment of the current flow through the first set of magnetic coils and the second set of magnetic coils.

19. The computer program product of claim 15, wherein to switch between the mechanical coupling position and the magnetic coupling position, the program instructions executable by the system to cause the system to:
transmit a signal to the first set of magnetic coils and the second set of magnetic coils to activate temporary magnetism to switch between the mechanical coupling position and the magnetic coupling position; and
generate a signal disengage, via a hydraulic component of the dual modality coupling module, a mechanical coupling shaft of the dual modality coupling module.

20. The computer program product of claim 19, wherein the mechanical coupling shaft is engaged and disengaged by the hydraulic component, and wherein the mechanical coupling shaft comprises a telescope mechanism to switch between the mechanical coupling position and the magnetic coupling position.
